(19) United States
(12) Patent Application Publication
(10) Pub. No.: US 2013/0027473 A1
(43) Pub. Date: Jan. 31, 2013

(54) CHARGE TRANSFER FROM A MOVABLE OBJECT

(71) Applicants: Bradley B. BRANHAM, Vancouver, WA (US); Steve A. O'Hara, Camas, WA (US); Denise Barger, Battle Ground, WA (US)

(72) Inventors: Bradley B. BRANHAM, Vancouver, WA (US); Steve A. O'Hara, Camas, WA (US); Denise Barger, Battle Ground, WA (US)

(21) Appl. No.: 13/194,375

(22) Filed: Jul. 29, 2011

(51) Int. Cl. B41J 2/14

(52) U.S. Cl. 347/50

(57) ABSTRACT

A system is disclosed, comprising a printhead to eject ink onto print media, an electrical component, a first electrode adjacent said component, a second electrode to transfer electric charge from said print media when the print media passes through the system, and an electrical conductor connecting the second electrode to the first electrode.

### BACKGROUND

A common way to form images on media, such as paper, card stock, or transparent film, is to use an electronic printer. One such printer, an ink jet printer, employs a fluid-ejection device, commonly called a printhead, to form images. A printhead ejects liquid ink in a precisely controlled manner, forming a stream of droplets that impact the print media. However, droplet formation can also produce an unwanted aerosol mist of very fine droplets. The aerosol floats through the air space of the printer and eventually plates or covers surfaces within the printer or is taken away by air currents.

### BRIEF DESCRIPTION OF THE DRAWINGS

For a detailed description of exemplary implementations, reference will now be made to the accompanying drawings in which:

FIG. 1 shows a schematic of an electronic printer in accordance with at least one implementation;

FIG. 2 shows a side view of the paper path of the printer in FIG. 1 in accordance with at least one implementation;

FIG. 3 shows a partial, break-away, sectional view of a printhead of the printer in FIG. 1 in accordance with at least one implementation;

FIG. 4 illustrates a schematic of a system to protect a component, e.g., an optical sensor, in accordance with at least one implementation;

FIG. 5 presents a perspective view of an electrode for the system shown in FIG. 4 in accordance with at least one implementation;

FIG. 6 is a perspective view of an optical sensor of the printer in FIG. 1 in accordance with at least one implementation;

FIG. 7 is a perspective view of the optical sensor of FIG. 6 coupled with an electrode like the one shown in FIG. 5 to facilitate the system to protect a component illustrated in FIG. 4 in accordance with at least one implementation;

FIG. 8 shows an alternate electrode for zone protection device of FIG. 4 in accordance with at least one implementation; and

FIG. 9 shows an alternate electrode for the system to protect a component shown in FIG. 4 in accordance with at least one implementation.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct or through an indirect connection via another device. The term “system” refers to a collection of two or more components and may refer to an entire assembly, or a portion of a larger assembly.

### DETAILED DESCRIPTION

The following discussion is directed to various implementations of the invention. The implementations disclosed should not be interpreted, or otherwise used, as limiting the scope of the disclosure, including the claims. In addition, one skilled in the art will understand that the following description has broad application, and the discussion of any implementation is meant only to be exemplary of that implementation, and not intended to intimate that the scope of the disclosure, including the claims, is limited to that implementation.

Various implementations are disclosed herein pertaining to the protection of components from the impact of stray, fine particles such as might be found in an aerosol cloud of ink droplets or solid toner particles in a printer. In accordance with various implementations, particles are removed from, or inhibited from entering, a zone surrounding the component to be protected (“the protected component”). In some implementations, the protected component comprises an electrical component such as a sensor (e.g., an optical sensor). Electrical charge is transferred to or near the protected component by using the electrical charge that develops on or near a charged element. Thus, charge is transferred from the charged element to the protected component. Consequently, a protective electric field develops in the vicinity of the first component.

The protected component may be, for example, an optical sensor that is to be protected. Such sensors may be used, for example, to detect the presence of print media (e.g., paper) along a paper path in the printer. The charged element may be a sheet of print medium as it moves through a printer. As the print medium moves through the printer, an electrostatic charge (i.e., static electricity) develops on the medium as a result of moving contact with rollers or a fixed surface. The rolling or rubbing contact transfers electrons and establishes the electrical charge on the charged element (print medium) by a process called tribocharging. A method for protecting the protected component comprises installing an electrically conductive object (e.g., an electrode) near or around the protected component and establishing an electrical path from the charged element to the electrode.

The electrical path may be formed by a combination of physical features and natural phenomena. For example, at least a portion of the path may be formed by a conductive wire coupled to a second electrode positioned near the charged element. In some implementations, the second electrode comprises an electrostatic brush within a printer. Another portion of the path between the charged element and the protected component may result from dielectric break-down, such as the dielectric breakdown of an air gap between two objects with opposite electrical charges, e.g., the second electrode and the charged element. In some such implementations, the electric path may extend from the charged element, through an air gap, through a second electrode, through a wire, and to a first electrode at or near the protected component.

The arrangement, as described, may transfer electrical charge to the first electrode and create an electric field around the protected component. This arrangement may alter the electrical charge densities at or near the protected component and charged element in a way that, in some implementations, may result in a minimum energy electrical field between the component and element. In general, this effect tends to equalize the electrical charge density at or near the protected component and charged element with a net result of a reduced or nullified aggregate electrical field. The likelihood for stray particles to impact the protected component thereby may be diminished.

In various implementations, the disclosed system to protect the protected component is passive, meaning it does not require any additional electrical power to be supplied from an external source to achieve the desired benefit. In general, movable objects other than print media may develop an electrostatic charge by tribocharging. So, the principles and methods described herein may apply to systems other than printers.

An electronic printer, e.g., laser printer or ink jet printer, is one example of a system in which stray particles may impact various components degrading performance. An electronic printer is one example of a system that has components such as sensors that may be protected, e.g., shielded, in accordance with the principles disclosed herein.

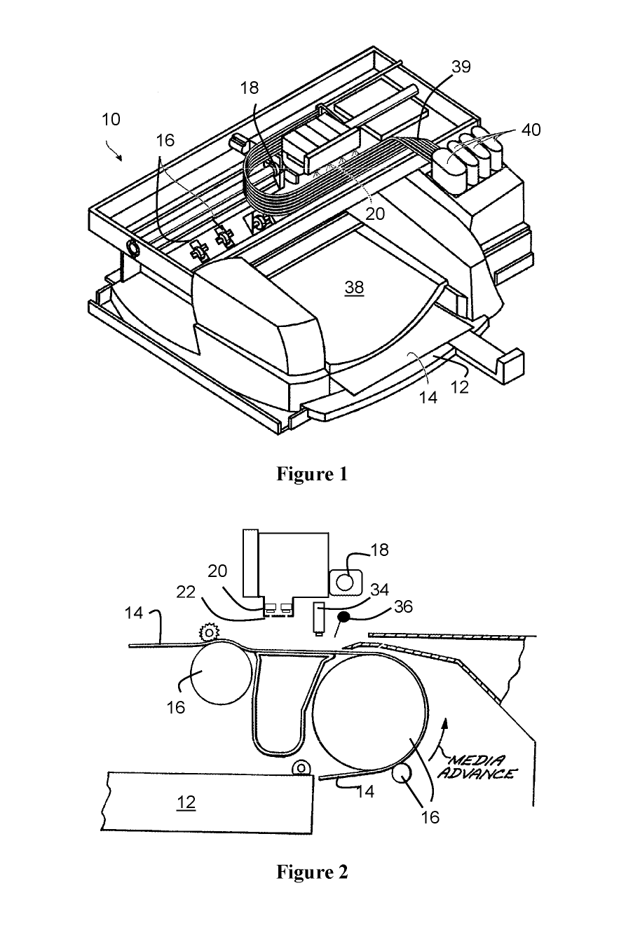

FIGS. 1 and 2 show a representative printer 10, according to an implementation of the present disclosure. In some implementations, the printer is an ink jet printer. As such, the printer 10 ejects and delivers a fluid (e.g., ink) onto a print media 14, to form images on the media. The printer 10 of FIG. 1 comprises, print media tray 12, a series of rollers 16, a sensor or other vulnerable component 34 (e.g., optical sensor), electrostatic brush 36, printhead 20, and an output tray 38 that receives the printed media after it passes through the printer.

Media tray 12 stores print media 14 pending its use in printing images. Various types of print media, such as paper, card stock, or plastic film, may be used. Rollers 16 deliver print media 14 (i.e., the charged element from the discussion above) through the printer. Optical sensor 34 (i.e., the protected component from the discussion above) detects the presence or type of media. At least one electrostatic brush 36 (i.e., second electrode from the discussion above) discharges static electricity that develops on the print media as it moves through printer 10 by force of rollers 16. Printer 10 includes at least one printhead 20 that is either fixed in place or is mounted on a moving carriage 18. A moving printhead will be assumed in the current discussion, although the use of a non-moving, page wide array printhead assembly can also be used. Carriage 18 scans printhead 20 back and forth across the print media 14, perpendicular to the direction of travel of print media 14, which is indicated in FIG. 2.

Printer 10 converts electronic data into electrical signals that are sent to printhead 20 to form a pattern of drops that produces a desired text or image (not shown) on print media 14. Printer 10 may receive the electronic data from an integrated circuit within the printer, from an external computer or computer network, or from a separate, stand-alone memory device. The data source (not shown) may be coupled directly or indirectly to the printer through wires or through a wireless, electromagnetically transmitted signal.

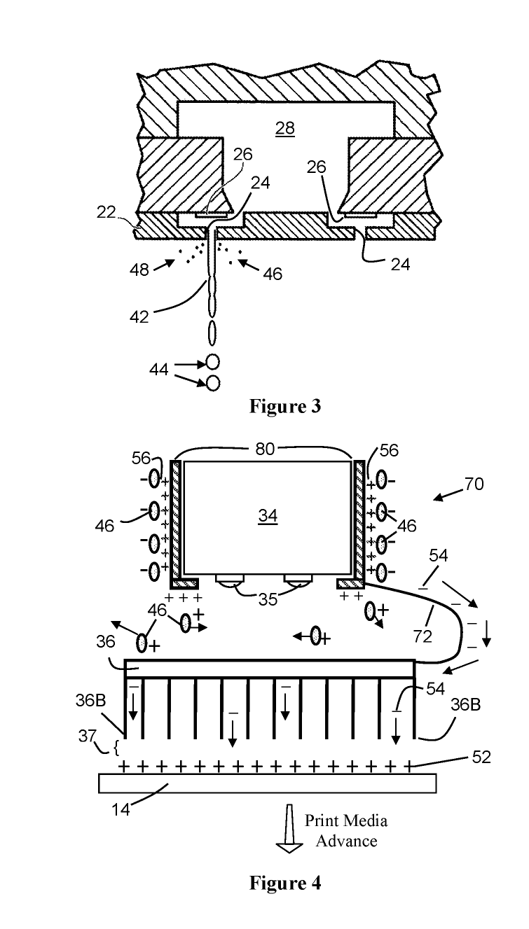

Referring to FIGS. 1 and 3, for printer 10 to produce an image on print media 14 a fluid (e.g., ink) from a reservoir 40 is routed into a printhead 20. Each reservoir 40 may be directly coupled to a printhead or may be indirectly coupled by a fluid supply hose 39. The printhead has at least one internal channel 28, at least one channel for each color of ink. At the end of each channel is at least one small through-hole or orifice 24 through which the ink is ejected in order to form individual droplets that impact print media 14. The orifices 24 are also referred to as nozzles. Orifices 24 are disposed in a die or orifice plate 22.

For a printhead 20 to eject fluid through an orifice 24, the fluid is pushed, e.g., mechanically forced by an adjacent firing element 26. Printhead 20 uses any suitable method of forcing the fluid through orifice 24. In one type of printhead, for example, the fluid is thermally forced through the orifice 24. Inside the print head, near each orifice, a small resistor (not shown) is used as a firing element 26. The resistor electrically heats the fluid, forming a vapor bubble within the fluid. The expansion of the vapor bubble forces fluid through orifice 24. The resistor is cycled on and off to control the release of fluid. Another type of printhead uses a piezoelectric material near orifice 24 to act as firing element 26. Electrical signals alternately deform and relax the piezoelectric material, producing pressure pulses in the fluid, forcing some fluid through orifice 24.

Still referring to FIG. 3, fluid initially exits orifice 24 as a fast-moving cylindrical stream or jet 42. As stream 42 leaves orifice 24, competition develops between the viscosity of the fluid, which tends to cause the stream to continue flowing cohesively, and the surface tension of the fluid, which tends to pinch the stream into droplets. This competition establishes an instability in the fluid steam called Rayleigh instability. Ultimately, surface tension dominates and the stream breaks into multiple droplets, which tend to be non-uniform in size (not shown).

More than just pushing the fluid, the mechanical forcing of firing element 26 produces periodic pressure waves (pulsations) in exiting stream 42. The pressure waves encourage the Rayleigh instability, inducing stream 42 to break into uniformly sized, precisely timed droplets 44. The ejection of uniformly sized, precisely timed droplets is coordinated with the timed movements of printhead 20 on carriage 18 and the movement of print media 14 to form the intended image on print media 14.

In addition to the uniformly sized, precisely timed droplets, much smaller, extraneous droplets 46 also form as the fluid leaves the orifice. These fine (very small) droplets or particles 46 form an aerosol cloud 48 that floats within the air space of the printer.

Upon separating from fluid stream 42, the individual, fine particles 46 that form this unwanted, stray aerosol cloud 28 may have a positive or negative electrical charge or may be neutral. Charged particles (i.e., droplets) can be formed if the source fluid (i.e., ink) is electrolytic, meaning the fluid contains positively charged ions (sub-molecules) and negatively charged ions. A stream, or jet, of electrolytic fluid, such as stream 42, can be induced by external factors to segregate into regions of positive and of negative ions in a process called jet polarization. Jet polarization results in a charge gradient within the fluid stream. The presence of an electric field can cause a fluid stream exiting the printhead orifice to polarize. As result, the fine droplets or particles 46 that break away from stream 42 may contain positive or negative ions and therefore may carry an electrical charge. The presence and source of an electric field within the printer will be explained next.

Referring to FIG. 2, during printing, rollers 16 draw print media 14 from the tray 12 and feed the print media through printer 10, passing under printhead 20. As the rollers 16 contact and release print media 14, an electrostatic charge is created on print media by the phenomenon of tribocharging. Tribocharging is the same phenomenon by which, for example, a static electric charge develops on an inflated rubber balloon and on a person's hair when the two are rubbed together causing them to adhere to one another. In a printer, tribocharging means that electrons are stripped (taken) from the surface of print media 14 by the rollers 16. This results in a positive charge on the print media 14 as it moves through printer 10.

In general, depending on the material of rollers 16 and the material of print media 14, a positive or negative charge may be induced on the print media by giving or taking charged particles, e.g., electrons. Either situation is applicable to the current disclosure. The discussion herein will assume a positive charge is generated on print media 14.

An electrically charged element, such as moving print media 14, creates an electric field (sometimes called an electrostatic field) capable of repelling and attracting other particles. The electric field extends beyond the geometric, i.e., physical, boundaries of the charged element. Fine droplets (particles) of ink can be influenced by the electric field extending from the charged print media 14. Due to their small size, fine particles 46, which may be grouped within a floating aerosol cloud, are particularly susceptible to the electric field. When a particle is charged, the field can act through a Lorentz force. If the particle has no charge, i.e., is electrically neutral, a Kelvin force may act on the particle if the surrounding electric field is non-uniform. In particular, a Kelvin force may act on neutral droplets that are formed from electrolytic fluids or from fluids with polar molecules. A droplet of electrolytic fluid is considered to be neutral if the droplet contains and equal or nearly equal number of positive and negative ions. So, both charged and uncharged particles can be influenced to move by the electric field emanating from a charged object. The extent of this influence depends on the strength and polarity of the object's charge, the size and the charge of the floating particle, and other factors.

Consider a positively charged fine droplet within the floating aerosol cloud 48 that drifts through the electric field of print media 14. Since this droplet has the same electrical charge as the print media, the droplet is repelled from the print media and may thereby impact a printer component, such as optical sensor 34. Slowly, over time, a thin film of dried ink may plate the optical sensors 34, reducing the effectiveness of the sensor.

In FIG. 2, an electrostatic brush 36 is installed over the path of print media 14. Brush 36 generally spans the width of the print media. Preferably, brush 36 does not contact print media 14 but is held at a predetermined distance from the media. The separation distance may be from 1 to 4 mm in some implementations but can be other distances as desired.

In some printers, an electrostatic brush, like brush 36, may be connected to an electrical ground. With such a connection, the brush can reduce the electrical charge on the print media and thereby reduce the electric field, which is the driving force that repels small fluid particles, like particles 46. However, an external connection to electrical ground is not always available, and the external or internal connection to electrical ground is sometimes poor. For example, the electrical connection to ground may be broken or may be faulty due to a manufacturing defect. Consequently, the effectiveness of the brush can be hindered.

An implementation of a zone protection device 70 is illustrated in FIG. 4. Zone protection device 70 comprises an electrostatic brush 36 connected by an electrical conductor, such as a wire 72, to at least one electrode 80. In FIG. 4, the cross-section portions of two elements are labeled as electrode 80, these may be parts of a single entity or may be two separate pieces. In either case, they are electrically coupled to each other and to wire 72. Electrode 80 is installed near or around a component to be protected, e.g., optical sensor 34. In some implementations, electrode 80 may physically contact optical sensor 34 or may be held at a distance from sensor 34. In some implementations the distance between the inner surface of electrode 80 and the outer surface of optical sensor 34 is 1 to 8 mm. In some implementations, more than one electrode 80 may be connected by a wire 72 to brush 36 to protect more than one sensor 34. Brush 36, wire 72, and electrode 80 are electrically isolated from electrical ground.

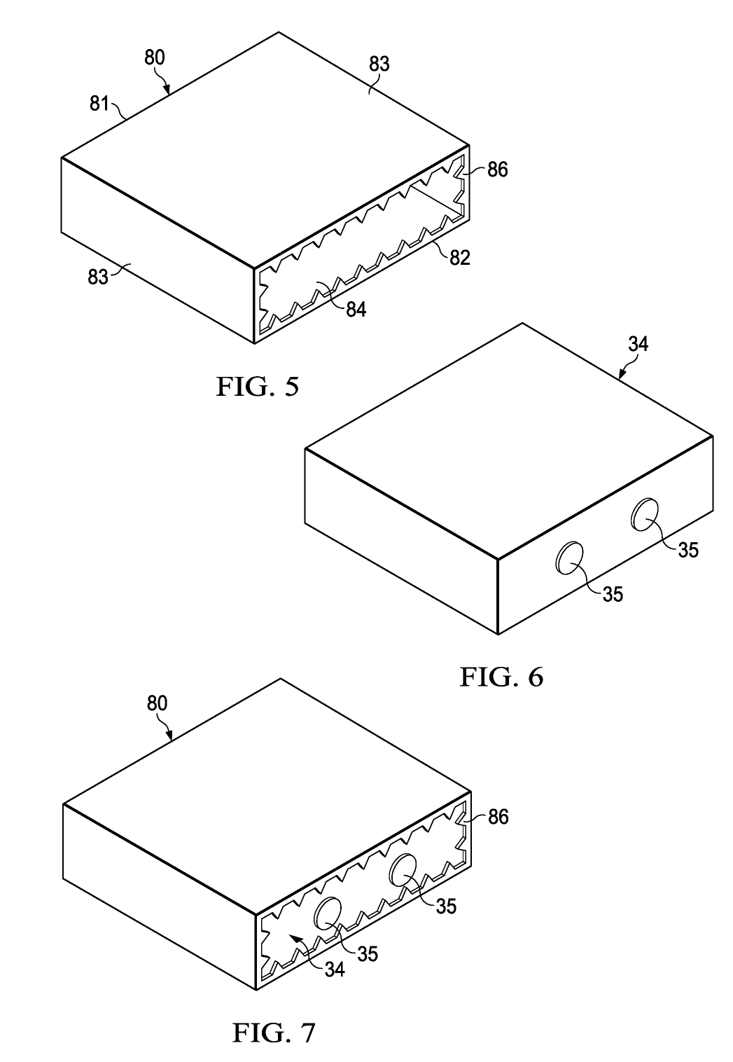

Referring to FIG. 5, in the one implementation, electrode 80 is formed as a hollow box, substantially open at a first end 81 and having a second end 82 with a generally rectangular hole 84. Electrode 80 has sidewalls 83. The shape of electrode 80 and hole 84 are appropriate to protect components shaped, in general, like a rectangular prism, as is optical sensor 34 in FIG. 6. The size and shape of electrode 80 and of hole 84 can be modified to match the size and spacing requirements for the component that is to be protected. In FIG. 7, optical sensor 34 is coupled with an implementation of electrode 80. Electrode 80 does not obscure or interfere with the performance of the active elements 35 of optical sensor 34.

Referring to the implementations in FIGS. 5 and 7, the edge of hole 84 is lined with at least one sharp edge, sharp protrusion, or sharp point 86. A sharp edge or point defines an electrode architecture capable of creating non-uniformities in the electric field emanating from the electrode. For example, a sharp point or edge may be a protrusion that is much smaller than adjacent objects or much smaller than adjacent portions of the same object. Alternately, a sharp point or edge may be the narrowing end of an object wherein the object is characterized by an angle of less than ninety degrees. In the examples of FIGS. 5 and 7 sharp points 86 comprise triangular teeth spaced around the sides of a generally rectangular hole 84. The root, or base, of each tooth is spaced a predetermined distance from the root of adjacent teeth. The longer sides of hole 84 are shown with nine sharp points 86. The shorter sides have two sharp points 86. In general, the placement, spacing, size, and shape of the sharp points may differ from one implementation to another or may vary within a single implementation. Adjacent sharp points may overlap or contact each other. The sharp points might not be symmetrical, and the placement of sharp points around hole 84 might not be uniform or symmetrical. Sharp points 86 may be positioned in one or more corners of rectangular hole 84.

The sharp points 86 may be flat, lying entirely within the planar region that contains end 82 (as shown), or the sharp points 86 may, in some manner, point outward, away from end 82. Electrode 80 may be mechanically coupled to optical sensor 34 or to the printer body adjacent to sensor 34. Although not shown, electrode 80 may include tabs, holes, slots, adhesive, or other elements to facilitate this coupling.

Referring to FIG. 4, when zone protection device 70 is installed inside a printer 10 (FIG. 1), the positive charge 52 on moving print media 14 attracts and siphons, or bleeds, electrons 54 (negative charges) from the stationary electrostatic brush 36 even though print media 14 and brush 36 do not touch. The transfer of electrons between media 14 and brush 36 actually occurs through the tips 36B of brush 36. For simplicity, brush 36 as a whole will be usually referenced. The transfer of electric charge between print media 14 and brush 36 results from the dielectric break-down within the air gap 37 that separates the two objects 14, 36. Dielectric break-down means that electrical charge can be transferred through a medium, such as air, that otherwise acts like an electrical insulator. Dielectric break-down is exemplified by the shock and arc that sometimes occur when a person rubs his feet across carpeting and moves his hand near a metal object. Lightning is an example of dielectric breakdown between clouds and the earth. Of course, lightning is a much, much more powerful event than occurs inside a printer.

For dielectric break-down to occur, the electric field between two objects, e.g., media 14 and brush 36, must have sufficient strength. Electric field strength is proportional to the voltage difference and inversely proportional to the distance between objects 14, 36. Electric field strength can be measured, for example, in units of volts per meter. Referring to FIG. 4, the tips of brush 36 in printer 10 (FIG. 1) are fixed sufficiently near the print media 14 to insure dielectric break-down is possible. As indicated previously, media 14 starts with a greater positive electrical charge than brush 36; hence, a voltage difference exists.

As print media 14 takes electrons 54 from brush 36, brush 36, in turn, takes electrons 54 from electrode 80 via wire 72. Electrode 80 loses electrons 54 and thereby develops a positive charge 56. As this exchange of electrons continues, the density of the positive electrical charge 56 on electrode 80 becomes more and more similar in magnitude to the density of the remaining positive charge 52 on print media 14. This equalization process reduces the electrical field strength between media 14 and tips 36B of brush 36. The transfer of electrons 54 from the electrode 80 to the print media 14 continues until said electrical field strength drops below a threshold level. In some situations, the threshold level will be on the order of 3×10̂6 V/m. Alternately, rather than describing the path of the negatively charged electrons, this process can be described in terms of a positive electrical charge being transferred from the print media 14 to brush 36 and ultimately to electrode 80.

As described earlier, tribocharging develops an electrostatic charge on print media 14 as the print media contacts and moves relative to the rollers 16. Similarly, the term “tribological discharge” describes the reduction in that electrostatic charge on print media 14 through the influence of zone protection device 70.

Because brush 36 reduces the positive charge 52 that develops on print media 14 by distributing the charge to electrode 80, the strength of the resulting electric field from media 14 is reduced, or partially suppressed. In the region around the print head, this partial suppression of the electric field will reduce the severity of the polarization of fluid stream 42. Therefore, more of the stray ink particles 46 will be neutral and less-susceptible to the force of the electric field.

A similar effect occurs in the region between print media 14 and the electrode 80. Since both the print media 14 and the electrode 80 have the same electrical charge (positive) and have a similar charge density, they both exert a similar electrical field force on particles that pass between them. Therefore in the region between media 14 and electrode 80, particles in the aerosol cloud may be less-influenced by an electric field to move toward or away from either print media 14 or the electrode 80. The result may be called electric field nullification or electric field suppression in the macro-region between the two charged objects 14, 80. Other factors such as momentum, buoyancy, drag, and convective currents continue to influence particle 46 movement.

Even so, fine particles 46 of stray aerosol cloud 48 that come nearer media 14 may be repelled. However, electrode 80 has a similar electrical charge 56 that can also repel positively charged particles 46 particles, protecting sensor 34. Additionally, electrode 80 may collect negatively charged particles before they can land on sensor 34 as illustrated in FIG. 4.

However, in the very near vicinity of electrode 80, sharp points 86 create a non-uniform electric field, which is characterized by a very high field gradient. Since the constituents, i.e., particles, of the aerosol cloud are very small, the Kelvin force may deflect them away from the protected area. That is to say, the non-uniform electric field may repel the aerosol cloud particles that travel to and arrive nearby the component that is to be protected, i.e., optical sensor 34. In this way, in the example of FIG. 4, zone protection device 70 establishes a protected zone around optical sensor 34.

Zone protection device 70 provides protection against the impact of stray aerosol droplets in the region or zone where the electrode 80 is installed. One or more zone protection devices 70 may be installed in a printer such as printer 10. Zone protection device 70 may be implemented as a passive component in some implementations. Therefore, in some scenarios, device 70 does not require electricity from a power source, such as, for example, an electrical transformer, a battery, or a power supply. In such a scenario, electrostatic brush 36 is not coupled to a power source. Instead, an electric charge may develop on the print medium 14 due to moving contact with rollers 16 or a fixed surface. The electric charge would become the driving force that energizes device 70 to protect optical sensor 34. In the process, electrostatic brush 36 may transfer the charge between print medium 14 and electrode 80. The transfer of charge may occur through an electrical path that may include conductive wire 72 and air gap 37, which may be made electrically conductive by the occurrence of dielectric break-down.

Alternatively, zone protection device 70 may be actively powered by a transformer, a battery, a power supply, or another source of electrical power.

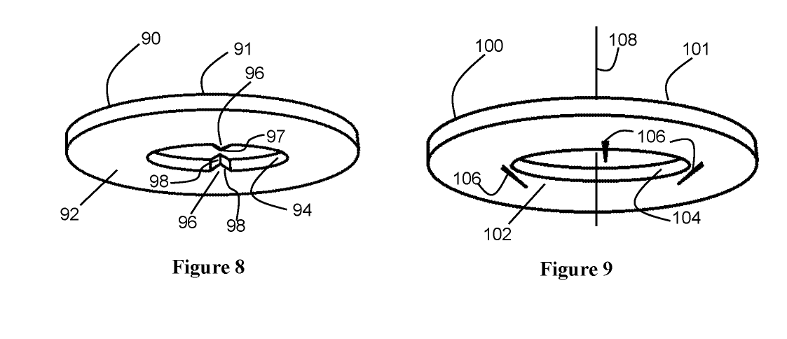

Referring to FIG. 8, a second implementation uses an electrode 90. Electrode 90 is formed as substantially flat disc, but it may have a rectangular, triangular, or another geometric profile. Electrode 90 comprises two opposing surfaces 91, 92. Sidewalls are not shown but may be added. The size and shape of electrode 90 and hole 94 can be modified to match the size and spacing requirements for the component that is to be protected.

Electrode 90 has a central hole 94 lined with at least one sharp point or sharp edge. In some implementations, electrode 90 may have more than one sharp point or sharp edge. In some implementations electrode 90 may incorporate both sharp features. In the disclosed embodiment, the sharp features are built into at least one sharp tooth 96 located on central hole 94. FIG. 8 illustrates two, diametrically opposed sharp teeth 96 that are generally triangular in shape. These two sharp teeth 96 individually comprise both a sharp edge 98 and sharp points 97. In FIG. 8, sharp teeth 96 do not protrude beyond the planes defined by surfaces 91, 92. In general, the quantity, placement, spacing, size, and shape of sharp teeth 96 may differ from one implementation to another or may vary within a single implementation.

Electrode 90 may be mechanically coupled to optical sensor 34 or to the printer body adjacent to sensor 34. Although not shown, electrode 90 may include tabs, holes, slots, adhesive, or other elements to facilitate this coupling. The component to be protected, e.g., optical sensor 34, may be imbedded in the body of printer 10 or carriage 18 so that only one surface of optical sensor 34 is potentially exposed to stray aerosol cloud 48. For this reason or another reason, electrode 90 may be adjacent to and cover only one surface of optical sensor 34. A system may use one or more electrode 90.

FIG. 9 illustrates electrode 100 that may be used in a third implementation. Electrode 100 is formed as substantially flat disc, but it may have a rectangular, triangular, or another geometric profile. Electrode 100 comprises two opposing surfaces 101, 102. Sidewalls are not shown but may be added. Electrode 100 has a central hole 104 lined with at least one sharp point or tooth 106. Three sharp points 106 are shown in the example of FIG. 9. Sharp points 106 have a needle-like shape and extend away from surface 102 of electrode 100, generally pointing toward the axis 108 that passes through the center of hole 104. The quantity, placement, spacing, size, and/or shape of sharp points 106 may differ from one implementation to another or may vary within a single implementation. Electrode 100 may be mechanically coupled to optical sensor 34 or to the printer body adjacent to sensor 34. Although not shown, electrode 100 may include tabs, holes, slots, adhesives, or other elements to facilitate this coupling. Like electrode 90, electrode 100 may be adjacent to and cover only one surface of optical sensor 34. A system may use one or more electrode 100.

Various implementations of zone protection device 70 may use electrode 80, 90, or 100 or may use a combination of electrodes 80, 90, and 100 or other electrodes that serve the same purpose. In any such implementation, the application of zone protection device 70 would be in keeping with the methods disclosed herein.

The above discussion is meant to be illustrative of the principles and various implementations of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a printhead to eject ink onto print media;
an electrical component;
a first electrode adjacent said component;
a second electrode to transfer electric charge from said print media when the print media passes through the system; and
an electrical conductor connecting the second electrode to the first electrode.

2. The system of claim 1 wherein the first electrode develops a non-uniform electric field around the component.

3. The system of claim 1 wherein the component comprises a sensor.

4. The system of claim 1 wherein the first electrode comprises a sharp point.

5. The system of claim 1 wherein the first electrode comprises a plurality of sharp points.

6. The system of claim 1 wherein the first electrode comprises a sharp edge.

7. The system of claim 1 wherein the first electrode is within 8 millimeters of said component.

8. The system of claim 1 wherein the second electrode is isolated from electrical ground.

9. The system of claim 1 wherein the second electrode is an electrostatic brush and is not coupled to a power source.

10. The system of claim 1 wherein the second electrode does not touch the print media.

11. A system, comprising:
a printhead to eject ink droplets onto print media;
an electrical component;
a first electrode adjacent said component, wherein, said electrode comprises at least one sharp edge or point;
a second electrode to transfer electric charge from said print media when the print media passes through the system; and
an electrical conductor connecting the second electrode to the first electrode.

12. The system of claim 11 wherein the first electrode develops a non-uniform electric field around the component.

13. The system of claim 11 wherein the component comprises a sensor.

14. The system of claim 11 wherein the first electrode comprises a plurality of sharp edges or points.

15. The system of claim 11 wherein the first electrode is within 8 millimeters of said component.

16. The system of claim 11 wherein the second electrode is isolated from electrical ground.

17. The system of claim 11 wherein the second electrode is an electrostatic brush and is not coupled to a power source.

18. The system of claim 11 wherein the second electrode does not touch the print media.

19. A printer, comprising:
a printhead to eject ink droplets onto print media;
an optical sensor;
an electrode adjacent said optical sensor to protect the optical sensor, wherein, said electrode comprises at least one sharp edge or point;
an electrostatic brush to transfer electric charge from said print media when the print media passes through the printer, wherein the electrostatic brush does not touch the print media; and
an electrical conductor connecting the electrostatic brush to said electrode;
wherein the electrostatic brush, the electrical conductor, and the electrode are isolated from electrical ground; and
wherein the electrostatic brush is not coupled to a power source.

20. The printer of claim 19 wherein the electrode is within 8 millimeters of said optical sensor.
